(19) United States
(12) Patent Application Publication
(10) Pub. No.: US 2005/0074998 A1
(43) Pub. Date: Apr. 7, 2005

(54) Tool Joints Adapted for Electrical Transmission

(76) Inventors: David R. Hall, Provo, UT (US); Joe Fox, Spanish Fork, UT (US)

Correspondence Address: JEFFREY E. DALY;GRANT PRIDECO, L.P., 400 N. SAM HOUSTON PARKWAY EAST, SUITE 900, HOUSTON, TX, 77060, US

(21) Appl. No.: 10/605,484

(22) Filed: Oct. 2, 2003

(51) Int. Cl. H01R 4/60

(52) U.S. Cl. 439/191

(57) ABSTRACT

Connectable tool joints which are adapted for electrical transmission without increasing their cross-sectional area adjacent their respective secondary shoulders. The tool joints comprise a plurality of threads intermediate primary and secondary shoulders. The tool joints further comprise a cross-sectional area adjacent their respective secondary shoulders that act cooperatively to withstand an overload condition of the connected tool joints during operation. Openings within the cross-sectional area adjacent the secondary shoulders comprise a volume that is more than 50% less than what is required to fail the secondary shoulder adjacent the opening during an overload condition of the tool joint. The respective openings are adapted to receive electrical transmission elements, and when the tool joints are connected, the respective elements are substantially aligned to enable electrical transmission across the connected tool joints. The electrical transmission elements are suitable for transmitting power and or data along the drill string between surface and subterranean equipment.

### FEDERAL RESEARCH STATEMENT

This invention was made with government support under Contract No. DE-FC26-97FT343656 awarded by the U.S. Department of Energy. The government has certain rights in the invention.

### BACKGROUND OF INVENTION

This invention relates to drill string tool joints useful in drilling oil, gas, and geothermal wells adapted for electrical transmission downhole without increasing their cross-sectional area adjacent their secondary shoulders. More particularly, this invention relates to tool joints having openings within the cross-sectional area adjacent their secondary shoulders comprising a volume that is more than 50% less than what is required to plastically deform the secondary shoulders adjacent the openings during an overload condition of the tool joint.

It has long been determined that great advantage may be gained in drilling oil, gas, and geothermal wells if it were possible to achieve real time communication between surface and subterranean equipment, including the drill bit. Over the years, many attempts have been made to design and commercialize a transmission system for a drill string. However, to date no network for the transmission of power and data has achieved commercial status. A salient factor for the lack of a commercial system has been the difficulty in adapting commercial drill string tool joints for inclusion of the transmission elements necessary to accomplish transmission between surface and subterranean equipment.

Therefore, it is an object of this disclosure to provide a tool joint adapted for the inclusion of the transmission elements necessary to achieve electrical transmission across the tool joint in a drill string.

The secondary shoulder of double shouldered tool joints has been determined a suitable platform for adapting downhole tools for inclusion in a transmission network to provide real time power and data communication downhole.

Examples of a double shouldered tool joints for downhole tools, such as drill pipe and the like, are presented in U.S. Pat. No. 2,532,632, to MacArthur, U.S. Pat. No. 4,521,042, to Blackburn; U.S. Pat. No. 4,548,431, to Hall et al.; U.S. Pat. No. 5,492,375, to Smith; and U.S. Pat. No. 5,908,212, to Smith et al., each of which is incorporated herein by these references for all that they teach and claim.

It is a further aim of this disclosure to provide an adaptation for electrical transmission that is generally transparent to commercial tool joints, that is to say that electrical transmission elements are added to the tool joint of this disclosure without the need to increase the cross-sectional area of the tool joint.

### SUMMARY OF INVENTION

The present invention provides double shouldered connectable tool joints which are adapted for electrical transmission without increasing their cross-sectional area adjacent their respective secondary shoulders. The connectable tool joints are either pin end tool joints or box end tool joints having primary and secondary shoulders. The presence of a secondary shoulder strengthens the connection in overload conditions during operation of the drill string. An overload condition is a torsional load on the tool joint that occurs when the make up torque on the tool joint is exceeded. The make up torque is usually approximately one-half the torsional yield strength of the tool joint, itself. The tool joints comprise a plurality of threads intermediate their primary and secondary shoulders. The tool joints further comprise a cross-sectional area adjacent their respective secondary shoulders that act cooperatively to withstand an overload condition of the connected tool joints that may arise during operation of the drill string. In adapting the tool joints for electrical transmission of power and data, openings are provided within the cross-sectional area adjacent the secondary shoulders comprising a volume that is slightly less than what is required to fail the secondary shoulder adjacent the opening during an overload condition of the tool joint. Failure of the tool joint adjacent the opening occurs when the region adjacent the opening is plastically deformed, damaging all or a portion of the opening. The respective openings are adapted to receive electrical transmission elements. These elements comprise magnetically conductive elements providing an inductive coupling between the connected tool joints, direct contact elements, or a combination of such elements. When the tool joints are connected making up a drill string, the respective transmission elements are substantially aligned and enable electrical transmission of power and or data across the connected tool joints. The electrical transmission elements then become part of a transmission network along the drill string suitable for transmitting power and or data between surface and subterranean equipment associated with the drilling operation.

### BRIEF DESCRIPTION OF DRAWINGS

FIG. 1 is a perspective diagram of a downhole tool.

FIG. 2 is a cross section of FIG. 1.

FIG. 3 is a cross section of FIG. 1 adapted for electrical transmission according to the present invention.

FIG. 4 is an enlarged diagram of connectable tool joints of the present invention adapted for electrical transmission.

FIG. 5 is another embodiment of connectable tool joints of the present invention adapted for electrical transmission.

### DETAILED DESCRIPTION

Provision for the transmission of power and data along a drill string is desirable for aiding real time communication between the surface and subterranean equipment necessary for the successful completion of a drilling operation. In order to provide for the transmission of power and or data downhole along a drill string network, it is necessary to adapt the various tools that make up the drill string to receive transmission elements such as inductive couplers, direct contact couplers, or couplers that incorporate a combination of inductive and direct contact systems. It is most desirable that these coupling mechanisms be robust enough to perform in the harsh environment downhole and, at the same time, be nearly transparent to normal drill string operations and the handling of the various components that make up the downhole drill string. Therefore, it is an object of this invention to provide adaptations to downhole tools for accomplishing the transmission of the power and or data along the drill string without changing the overall physical constraints of the drilling tools.

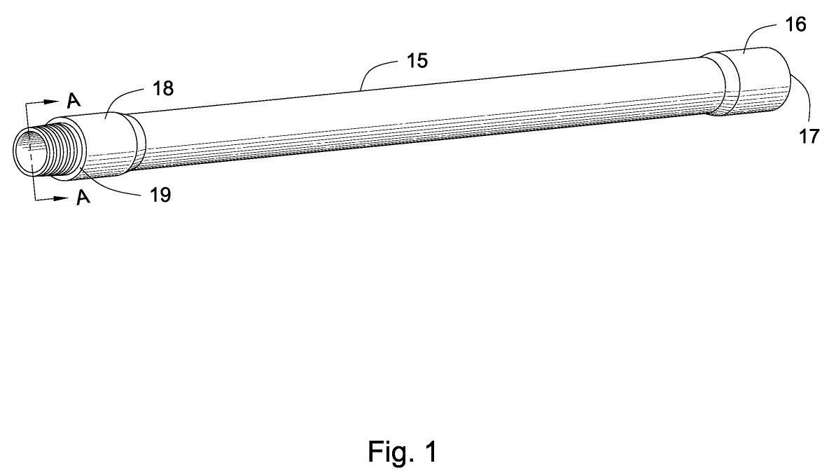

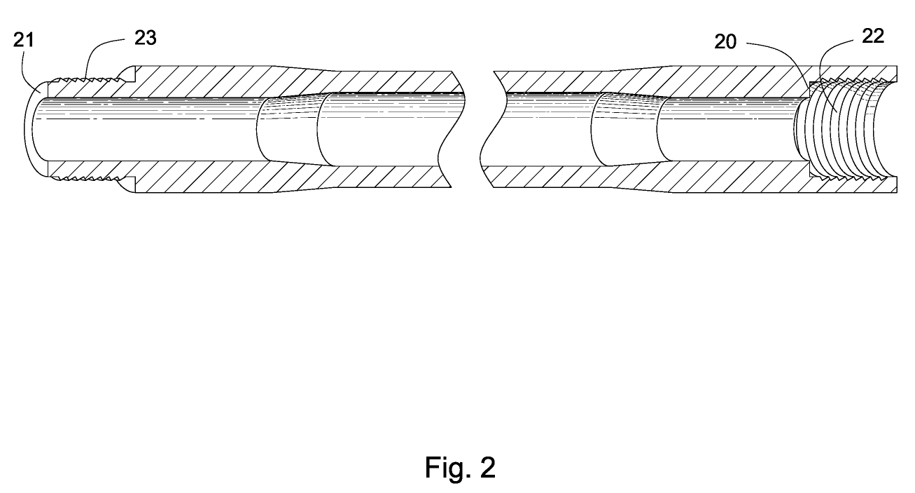

The present invention provides double shouldered connectable tool joints which are adapted for electrical transmission without increasing their cross-sectional area adjacent their respective secondary shoulders. FIG. 1 is a perspective diagram of a downhole tool that may be adapted for electrical transmission. The tool in FIG. 1 comprises a tubular mid section 15 intermediate a box end tool joint 16 and a pin end tool joint 17. The respective tool joints provide the means for connecting the tool in a drill string. The tool joints comprise external high-torque producing primary shoulders 17 and 19, respectively, that are placed under a torsional load during initial make up of approximately one-half of the torsional yield strength of the tool joints, themselves. Additionally, the tool joints comprise secondary shoulders as shown in FIG. 2 that enable the joints to withstand torsional overloads that may arise during the drilling operation. These secondary shoulders provide a suitable location for the adaptation of the downhole tool for electrical transmission.

Generally, the physical constraints depicted in FIG. 1 apply to all tools that form a drill string. Such tools include drill pipe, heavy weight drill pipe, drill collar, drilling jars, mud motors, shock absorbers, reamers, motors, hammers, steering subs, cross-over subs, swivels, mud sirens, perforators, compactors, and equipment for the gathering, storing, and transmitting of information. These tools, as well as others not mentioned, are incorporated into the drill string by means of the connectable tool joints that are either pin end tool joints or box end tool joints. Drill bits also use a tool joint for attachment to the drill string. Some tools may use more than one of each of the tools joint described. For example, a cross-over sub normally uses a pin end tool joint at both ends.

FIG. 2 is a cross section of FIG. 1 taken along line AA. FIG. 2 further depicts the box end internal shoulder 20 and the pin end internal shoulder 21. These are the secondary shoulders. The function of the secondary shoulders is to provide an additional torque producing surface area to handle torsional loads in excess of the make up torque that may be encountered during the drilling operation. The secondary shoulders provide a suitable location for the adaptation of the tool joint for electrical transmission without changing the physical constraints of the drilling tool. The presence of a secondary shoulder strengthens the connection in overload conditions during operation of the drill string. An overload condition is a torsional load on the tool joint that occurs when the make up torque on the tool joint is exceeded. The make up torque is usually approximately one-half the torsional yield strength of the tool joint, itself. As shown in FIG. 2, the tool joints further comprise a plurality of threads 22 and 23 intermediate their primary and secondary shoulders. These threads may have a slight taper and are designed to aid in the production of the high torque pre-load known as make up torque. Tool joints such as those depicted in FIG. 2 are obtainable from GrantPrideco, Houston, Tex. in a variety of weights and sizes.

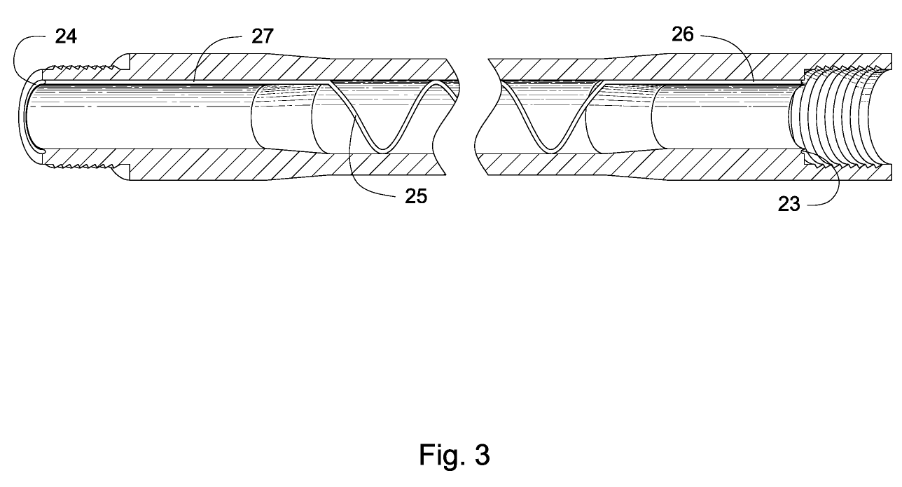

FIG. 3 is a cross-section diagram of FIG. 2 adapted for electrical transmission. FIG. 3 further comprises openings 23 and 24 adjacent the secondary shoulders which are suitable for the reception of the electrical transmission elements. The openings 23 and 24 are connected by an electrical transmission line 25 running through passageways 26 and 27 and the interior of the mid section of the tool.

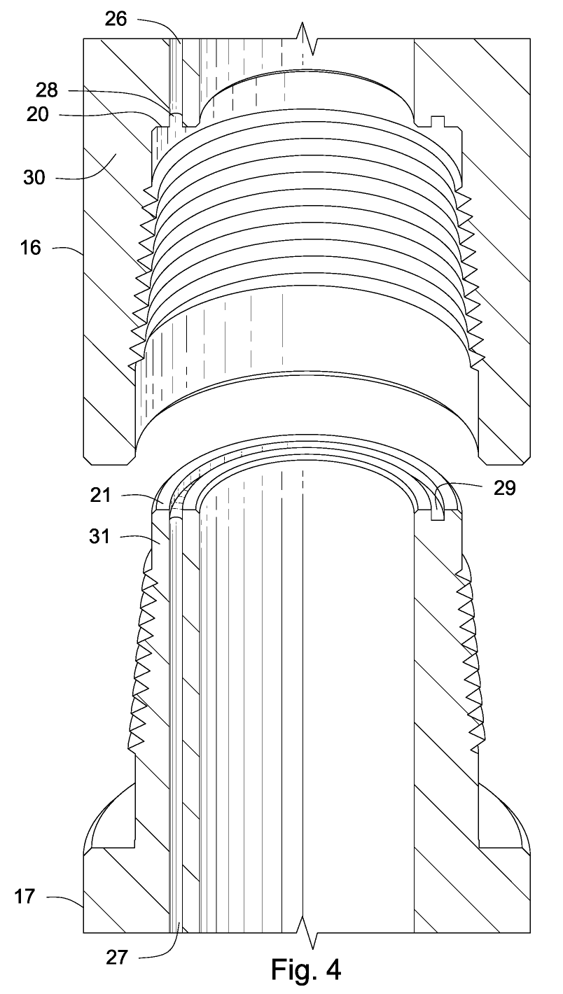

FIG. 4 is an enlarged view of the connectable tool joints depicted in the preceding figures. FIG. 4 illustrates the portion of the box end 16 and the pin end 17 which are suitable for inclusion of the electrical transmission elements. Box end 16 comprises internal secondary shoulder 20 provided with opening 28 which intersects passageway 26 leading to the interior of the mid section of the tool body. Pin end 17 comprises internal secondary shoulder 21 provided with opening 29 which intersects passageway 27 leading to the interior of the mid section of the connected tool body. Both the box end and the pin end comprise a cross-sectional area 30 and 31, respectively, which are sufficient to withstand the overload conditions that may be encountered downhole during the drilling operation, say for example when the drill string gets stuck. Although it may be possible to increase the cross-sectional areas of the box and pin ends in order to accommodate the inclusion of electrical transmission elements, this is not desirable, since it adds to the weight and cost of the drill string components and either compromises the fluid capacity of the tool's bore and or increases the diameter of the bore hole being drilled. Therefore, it is necessary that the modifications to the tool joints be transparent to the overall physical constraints of the tool joints.

The inclusion of the electrical transmission elements to the tool joints requires the removal of material from the regions adjacent the internal shoulders 20 and 21. As depicted in FIG. 4, an opening 28 is provided in box end 16 and a mating opening 29 is provided in pin end 17. When the tool joints are connected, these two opening come into alignment providing the means for the alignment of the transmission elements, also. Substantial alignment of the transmission elements is essential for efficient electrical transmission across the tool joint connection. The volume of these two openings must not compromise the torsional strength of the internal shoulders and reduce the overall yield capacity of the tool joint. The torsional strength of the tool joint is dependent on a number of factors including the number, taper, and configuration of the threads, and the cross-sectional area 30 and 31, respectively, of the box and pin adjacent the secondary shoulders. The cooperation of these elements to the torsional strength of the tool joint may be determined by finite element analysis (FEA). The addition of the openings 28 and 29 necessarily reduces this cross-sectional area and has the potential of adversely affecting the torsional strength of the secondary shoulders. FEA of the secondary shoulder regions of the box and pin ends under simulated overload conditions has shown that a slight reduction in the cross-sectional area of the regions adjacent the secondary shoulders will not compromise the strength of the shoulders. This allows for the openings 28 and 29 as depicted in FIG. 4. The slight reduction in the cross-sectional area of the respective shoulders should not exceed an opening within the cross-sectional area adjacent the secondary shoulders comprising a volume that is more than 50% less than what is required to fail the secondary shoulder adjacent the opening during an overload condition of the tool joint. Failure of the tool joint adjacent the opening means at least that plastic deformation of all or a part of the opening occurs under torsional overloads. Further, FEA analysis of the opening has shown that all or part of the opening will fail before the internal shoulder, itself, fails. It is believed that if the volume of the opening is 50% less than what is required to fail the secondary shoulder adjacent the opening, sufficient margin is provided to not only preserve the torsional strength of the secondary shoulder but also to protect the electrical components from damage in the event of failure of the shoulder adjacent the opening during overload conditions. Therefore, since the tool joints comprise a cross-sectional area adjacent their respective secondary shoulders that act cooperatively to withstand an overload condition that may arise during operation of the drill string, the integrity of the cross-sectional area must be preserved in any desired adaptation. In order to make the adaptation of the tool joint for electrical transmission transparent to standard downhole tools, it is essential that the volume of the openings in the pin and box ends be slightly less, say more than 50% less, than what would be required to fail the secondary shoulder adjacent the opening, thus providing a sufficient margin of safety for the tool joint overall, as well as for the electrical elements housed within the opening.

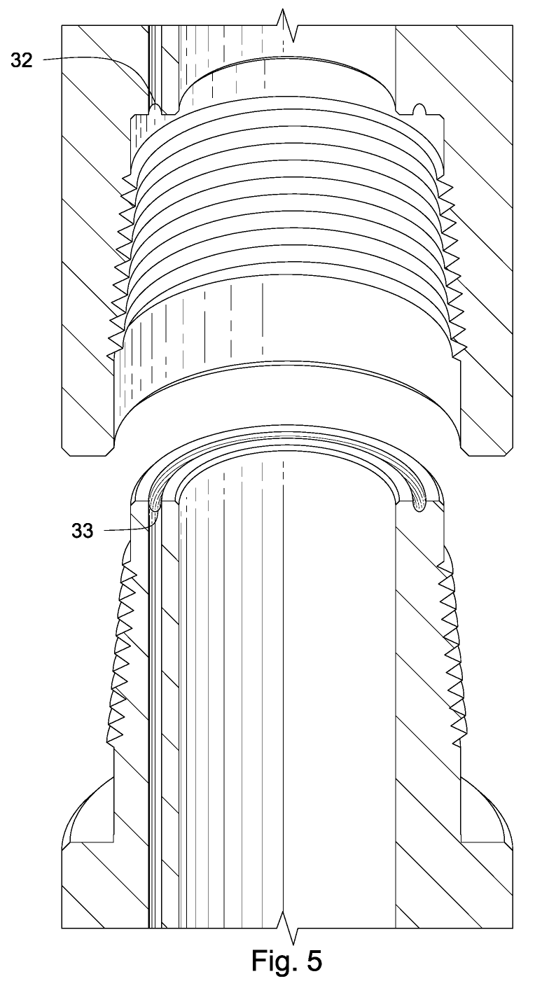

The openings 28 and 29 depicted in FIG. 4 comprise an annular trough having a square cross-section. FEA analysis has confirmed that the square section of the trough is a high-stress configuration limiting the permissible maximum volume for the trough. The volume of this high-stress trough may not be sufficient for the inclusion of efficient transmission elements. Therefore, a buttressed trough configuration is more desirable as depicted in FIG. 5.

FIG. 5 is another embodiment of FIG. 4 depicting buttressed troughs 32 and 33. A buttressed trough is an opening having side walls angled outwardly from the rounded distal portion of the trough. FEA has determined that the buttressed configuration is more efficient, providing the maximum volume for the inclusion of the electrical elements and at the same time providing the least affect on the torsional strength of the shoulder.

1. Connectable tool joints adapted for electrical transmission, comprising:
a plurality of threads intermediate primary and secondary shoulders;
the tool joints further comprising a cross-sectional area adjacent their respective secondary shoulders that acts cooperatively to withstand an overload condition of the connected tool joints;
an opening within the cross-sectional area adjacent the secondary shoulder comprising a volume that is 50% or less than what is required to fail the secondary shoulder adjacent the opening during an overload condition of the tool joint; and
wherein, the respective openings are adapted to receive electrical transmission elements, and when the tool joints are connected, the respective elements are substantially aligned to enable electrical transmission across the connected tool joints.

2. The tool joints of claim 1 comprising a pin end tool joint.

3. The tool joints of claim 1 comprising a box end tool joint.

4. The tool joints of claim 1, wherein the secondary shoulder comprises a pin end within the pin end tool joint.

5. The tool joints of claim 1, wherein the secondary shoulder comprises an internal secondary shoulder within the box end tool joint.

6. The tool joints of claim 1 connected to a tubular downhole tool selected from the group consisting of tools that make up a drill string for drilling oil, gas, and geothermal wells.

7. The tool joints of claim 1, wherein the cross-sectional area adjacent the secondary shoulders acts cooperatively with the threads to withstand an overload condition of the tool joint.

8. The tool joints of claim 1, wherein the openings comprise an annular trough.

9. The tool joints of claim 1, wherein the openings comprise a buttressed annular trough.

10. The tool joints of claim 1, wherein the openings intersect a passageway leading to the interior of a downhole tool selected from the group consisting of tools that make up a drill string for drilling oil, gas, and geothermal wells.

11. The tool joints of claim 1, wherein the electrical transmission comprises data.

12. The tool joints of claim 1, wherein the electrical transmission comprises power.

13. The tool joints of claim 1, wherein the electrical transmission elements comprise a magnetic inductive transmission system.

14. The tool joints of claim 1, wherein the transmission elements comprise a direct contact electrical system.

15. The tool joints of claim 1, wherein the transmission elements comprise a Hall Effect system.

16. The tool joints of claim 1, wherein the transmission elements comprise a combination of inductive and direct contact systems.

17. The tool joints of claim 1, wherein the transmission elements are in communication with subterranean and surface equipment.

18. The tool joints of claim 1, wherein the overload condition comprises a torsional load exceeding one-half the yield strength of the tool joints.

19. The tool joints of claim 1, wherein the failure of the secondary shoulder adjacent the opening comprises a deformation of at least a portion of the opening.

20. Connectable tool joints adapted for electrical transmission, comprising:
a plurality of threads intermediate primary and secondary shoulders;
the tool joints further comprising a cross-sectional area adjacent their respective secondary shoulders that act cooperatively to withstand an overload condition of the connected tool joints;
an opening within the cross-sectional area adjacent the secondary shoulder comprising a maximum volume that is less than what is required to fail the secondary shoulder adjacent the opening during an overload condition of the tool joint; and
wherein, the respective openings are adapted to receive electrical transmission elements, and when the tool joints are connected, the respective elements are substantially aligned to enable electrical transmission across the connected tool joints.
